(19) United States
(12) Patent Application Publication
(10) Pub. No.: US 2010/0192384 A1
(43) Pub. Date: Aug. 5, 2010

(54) Flexible pin for connecting a finger ring to a shank of a cutting device

(76) Inventor: Steven N. Fox, Weymouth, MA (US)

Correspondence Address: STEVEN N. FOX, ESQ., P.O. BOX 251, CANTON, MA, 02021, US

(21) Appl. No.: 11/919,168

(22) PCT Filed: May 9, 2007
(86) PCT No.: PCT/US2007/011154

§ 371 Date: Oct. 24, 2007

Related U.S. Application Data
(60) Provisional application No. 60/799,059, filed on May 9, 2006.

(51) Int. Cl. B26B 13/20; B23P 11/00

(52) U.S. Cl. 30/232; 403/408.1; 29/525.01

(57) ABSTRACT

The present invention is directed to a hair cutting device (10) such as a shear or scissor having a pivotal and flexible finger ring. In one embodiment, the shear comprises a first shank member (12) having a blade portion (14) and a handle portion (16) having a mounting hole (20). The hair cutting device (10) further comprises a closed finger ring (30) having a mounting hole (32). The hair cutting device (10) further comprises a flexible pin (34) for pivotally and flexibly attaching the finger ring (30) to the handle portion (16). The flexible pin (34) comprises a flexible body portion (36) having first and second end portions (38, 40). The flexible pin (34) further comprises first and second flexible flange portions (42, 44) disposed at the first and second end portions (46, 48), respectively; of the flexible body portion (36). The flexible pin (34) further comprises first and second flexible cut-away portions (46, 48) extending outward from the first and second end portions (38, 40) of the flexibly body portion (36). The first and second flexible cut-away portions (46, 48) may be inserted and pulled thru the mounting holes (32, 20) of the finger ring (30) and the handle portion (16) of the first shank member (12), respectively, until the first and second flexible flange portions (42, 44) pass thru the mounting holes (32, 20)of the finger ring (30) and the handle portion (16) of the first shank member (12), respectively, whereby the finger ring is pivotally and flexibly connect to the handle portion. A flexible washer or bushing (50) may be provided about the flexible body portion (36) to prevent any contact of the finger ring (30) with the handle portion (16).

### CROSS-REFERENCE TO RELATED APPLICATIONS

This application claims priority to U.S. Provisional Application Ser. No. 60/799,059 filed on May 9, 2006, now pending, which is hereby incorporated by reference in its entirety into this specification.

### BACKGROUND OF THE INVENTION

Cutting devices such as hair cutting shears or scissors are widely used by professional hair stylists. Conventional shears employ a thumb ring that is pivotally and flexibly attached to a handle of a shank. There is a continuing need to improve how the thumb ring is both pivotally and flexibly attached to the handle portion.

### SUMMARY OF THE INVENTION

The present invention is directed to a hair cutting device such as a shear or scissor. In one embodiment, the shear comprises a first shank member having a blade portion and a handle portion having a mounting hole. The shear further comprises a closed finger ring having a mounting hole. The shear further comprises a flexible pin for pivotally and flexibly attaching the finger ring to the handle portion. The flexible pin comprises a flexible body portion having first and second end portions. The flexible pin further comprises first and second flexible flange portions disposed at the first and second end portions, respectively; of the flexible body portion. The flexible pin further comprises first and second flexible cut-away extension portions extending outward from the first and second end portions of the flexibly body portion. The first and second flexible cut-away extension portions may be inserted and pulled thru the mounting holes of the finger ring and the handle portion of the first shank, respectively, until the first and second flexible flange portions pass thru the mounting holes of the finger ring and the handle portion of the first shank, respectively, whereby the finger ring is pivotally and flexibly connected to the handle portion. A flexible washer or bushing may be provided about the flexible body portion to prevent any contact of the finger ring with the handle portion.

### BRIEF DESCRIPTION OF THE DRAWINGS

The following description of the invention will be more fully understood with reference to the accompanying drawings in which:

FIG. 1 is a perspective view of a shear employing a flexible pin according to the present invention to pivotally and flexibly attach a finger ring to a handle portion;

FIG. 2 is a partial view showing the finger ring pivotally and flexibly attached to the handle portion of the shank with the first and second cut-away portions removed after assembly;

FIG. 3 is a plan view of the flexible pin;

FIG. 4 is a partial exploded view showing the first flexible cut-away extension portion of the flexible pin inserted thru the mounting hole of the finger ring;

FIG. 5 is a partial exploded view showing the first flange portion of the flexible pin pulled thru the mounting hole of the finger ring;

FIG. 6 is a partial exploded view showing the first flange portion of the flexible pin pulled thru the mounting hole of the finger ring and the first flexible cut-away extension portion removed;

FIG. 7 is a partial exploded view showing the second flexible cut-away extension portion of the flexible pin pulled thru the mounting hole of the handle portion of the first shank;

FIG. 8 is a partial exploded view showing the second flange portion of the flexible pin pulled thru the mounting hole of the handle portion; and

FIG. 9 is a partial exploded view showing the second flange portion of the flexible pin pulled thru the mounting hole of the handle portion and the second cut-away extension portion removed or cut-off.

### DESCRIPTION OF THE INVENTION

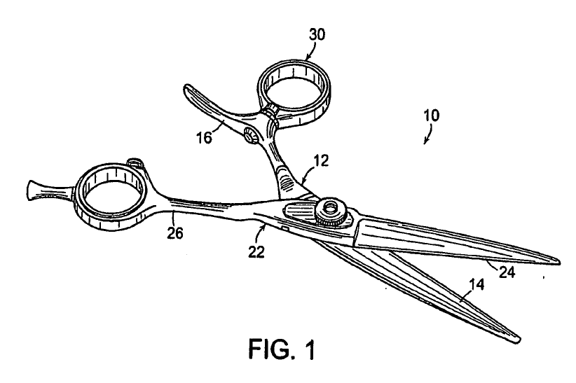

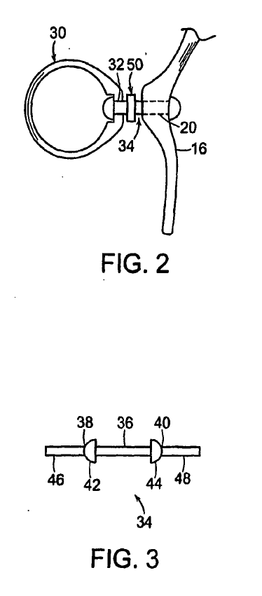

Referring to FIGS. 1-3, a cutting device or shear 10 generally comprises a first shank member 12, a second shank member 22, a finger ring 30, and a flexible pin 34. First shank member 12 generally comprises a blade portion 14 and a handle portion 16. Handle portion 16 has a mounting hole 20. Second shank member 22 generally comprises a blade portion 24 and a handle portion 26. First and second shank members 12 and 22 may be made from a variety of materials such as steel and formed by conventional molding and/or machining operations. Finger ring 30 generally comprises a closed loop body portion 31 and a mounting hole 32. In the embodiment shown, finger ring 30 may be designed for a person's thumb. Finger ring 30 may be made from a variety of materials such as metal or plastic and formed by conventional molding and/or machining operations.

Flexible pin 34 generally comprises a flexible body portion 36 having first and second end portions 38 and 40. Flexible pin 34 further comprises first and second deformable flange portions 42 and 44 disposed at the first and second end portions 38 and 40, respectively. Flexible pin 34 further comprises first and second flexible cut-away extension portions 46 and 48 extending outward from first and second end portions 38 and 40, respectively. As will be described more fully herein, first and second flexible cut-away extension portions 46 and 48 are inserted and pulled thru mounting holes 32 and 28 of the finger ring 30 and the handle portion 26, respectively, until first and second flange portions 42 and 44 pass thru mounting holes 32 and 38, respectively, whereby finger ring 30 is pivotally and flexibly engaged with handle portion 26. Flexible cut-away extension portions 46 and 48 are cut and removed. The diameter of the first and second flexible cut-away extension portions 46 and 48 may be the same or smaller than the diameter of the body portion 36 so that they can be inserted thru mounting holes 32 and 28, respectively. First and second flexible cut-away extension portions 46 and 48 may be tapered to assist in inserting thru the mounting holes 32 and 28, respectively. The flexible pin 34 may be made of any flexible and resilient material such as rubber and formed by conventional molding processes.

Shear 10 may further comprise a washer, o-ring or bushing 50 disposed about the body portion 36 of the flexible pin 36. Washer 50 prevents any unwanted surface contact between the finger ring 30 and the handle portion 16. The washer 50 may be made from any flexible and resilient material such as rubber. Washer 50 may also be made from a harder material such as nylon.

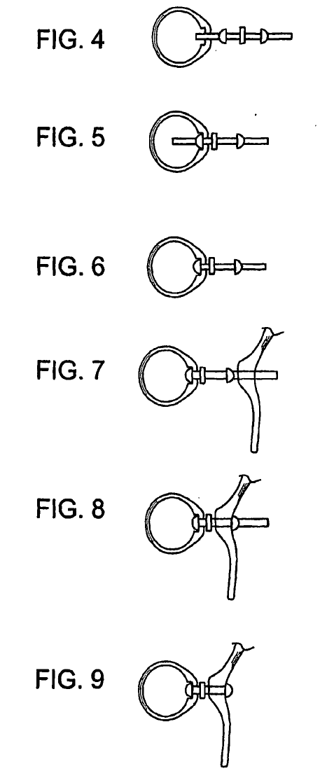

Referring to FIGS. 4-9, the method of attaching the finger ring 30 to the handle portion 26 with the flexible pin 34 may be carried out in various manual and/or automated ways. For example, as shown by FIG. 4, the washer or o-ring 50 may be disposed about the body portion 36 of the flexible pin 36 and the first flexible cut-away extension portion 46 may be inserted or passed thru the mounting hole 32 of the finger ring 30. As shown by FIG. 5, the first flexible cut-away extension portion 46 is pulled until the first flexible flange portion 40 passes thru the mounting hole 32 of the finger ring 30. As shown by FIG. 6, the first flexible cut-away extension portion 46 is removed or cut-off. As shown by FIG. 7, the second flexible cut-away extension portion 48 is inserted or passed thru the mounting hole 20 of the handle portion 16. As shown by FIG. 8, the second flexible cut-away extension portion 48 is pulled until the second flexible flange portion 42 passes thru the mounting hole 20 of the handle portion 16. As shown by FIG. 9, the second flexible cut-away extension portion 48 is removed or otherwise cut-off.

The present invention may be embodied in other specific forms without departing from the spirit and/or scope of the specification and appended claims. By way of example only, the washer, o-ring, or bushing 50 may be formed as part of, unitary, or integral with flexible body portion 36 in one molding process.

What is claimed:

1. A flexible pin for use with a finger ring of a cutting device comprising:
a) a flexible body portion having first and second end portions;
b) first and second flexible flange portions disposed at said first and second end portions, respectively; and
c) first and second flexible cut-away portions extending out from said first and second end portions of said body portion.

2. The flexible pin of claim 1, wherein said flexible body portion is cylindrically shaped.

3. The flexible pin of claim 2, wherein said first and second cut-away portions are cylindrically shaped.

4. The flexible pin of claim 3, wherein said diameter of first and second cut-away portions is smaller than said diameter of said flexible body portion.

5. A cutting device comprising:
(a) a first shank member having a blade portion and a handle portion having a mounting hole;
(b) a finger ring having a mounting hole;
(c) a flexible pin comprising a flexible body portion having first and second end portions; first and second flexible flange portions disposed at said first and second end portions, respectively; and first and second flexible cut-away portions extending out from said first and second end portions of said body portion; said first and second flexible cut-away portions being inserted and pulled thru said mounting holes of said finger ring and said first shank until said first and second flexible flanges pass thru said mounting holes of said finger ring and said first shank, respectively, whereby said finger ring is securely engaged with said handle portion of said first shank.

6. The device of claim 5, further comprising a washer disposed about said flexible body portion of said flexible pin.

7. The device of claim 6, wherein said flexible body portion is cylindrically shaped.

8. The device of claim 7, wherein said first and second cut-away portions are tapered.

9. The device of claim 8, wherein said diameter of first and second cut-away portions is smaller than said diameter of said flexible body portion.

10. The device of claim 9, where said flexible pin is made of rubber.

11. The device of claim 10, wherein said finger ring is made of metal.

12. A method of attaching a finger ring having a mounting hole to a shank of a cutting device having a mounting hole, the method comprising the steps of:
(a) providing a flexible pin comprising a flexible body portion having first and second end portions; first and second flexible flange portions disposed at said first and second end portions, respectively; and first and second flexible cut-away portions extending out from said first and second end portions of said body portion;
(b) inserting said first flexible cut-away portion thru said mounting hole of the finger ring;
(c) pulling said first flexible cut-away portion until said first flexible flange passes thru said mounting hole of the finger ring;
(d) inserting said second flexible cut-away portion thru said mounting hole of the shank; and
(e) pulling said second flexible cut-away portion until said second flexible flange passes thru said mounting hole of the shank ring.
